(19) United States
(12) Patent Application Publication
(10) Pub. No.: US 2021/0080532 A1
(43) Pub. Date: Mar. 18, 2021

(54) Coordinated Precoding and Beamforming of Position Purpose Signals

(71) Applicant: Nokia Technologies Oy, Espoo (FI)

(72) Inventors: Silvio MANDELLI, Tamm (DE); Stephan SAUR, Stuttgart (DE)

(21) Appl. No.: 16/967,163

(22) PCT Filed: Feb. 12, 2018
(86) PCT No.: PCT/EP2018/053390

§ 371 Date: Aug. 4, 2020

(51) Int. Cl. G01S 1/04; G01S 1/20

(52) U.S. Cl. CPC G01S 1/0428; G01S 1/20

(57) ABSTRACT

An apparatus, for use in a transmission device, is provided which comprises includes at least one processor, at least one memory including computer program code, and the at least one processor, with the at least one memory and the computer program code, being arranged to cause the apparatus at least to prepare at least one beamforming and/or precoding pattern for transmitting a positioning purpose signal via a plurality of antennas connectable to the apparatus, the positioning purpose signal serving to position at least one user equipment, and transmit the positioning purpose signal from the plurality of antennas according to the beamforming and/or precoding pattern. Beamforming and/or precoding may be coordinated between a plurality of transmission devices in a coordination scheme.

### FIELD OF THE INVENTION

The present invention relates to an apparatus, a method and a computer program product by which a coordinated precoding and beamforming of position purpose signals can be achieved.

### RELATED BACKGROUND ART

The following meanings for the abbreviations used in this specification apply:
BS Base Station
CN Control Network
GNSS Global Navigation Satellite System
GPS Global Positioning System
LS Location Server
NLOS Non-Line-of-Sight
OTDOA Observed Time Difference of Arrival
PRS Positioning Reference Signals
SINR Signal-to-Noise-and-Interference Ratio
S-PRS Supporting Positioning Reference Signals
S-UE Supporting User Equipment
T-UE Target User Equipment
UE User Equipment
VRU Vulnerable Road User

Embodiments of the present invention, although not limited to this, relate to positioning of devices such as UEs.

Accurate positioning of User Equipment (UE) with sub-meter accuracy becomes more and more important in many evolving use cases. As an example, the need of sufficient protection of Vulnerable Road Users (VRU), e.g., pedestrians, wheelchairs, and cyclists, from autonomously driving vehicles is widely discussed. For that, accurate and real-time positioning of both VRU and vehicle is required.

### SUMMARY OF THE INVENTION

Embodiments of the present invention address this situation and aim to improve accuracy of the UE positioning.

According to a first aspect of the present invention an apparatus, for use in a transmission device, is provided which comprises at least one processor, at least one memory including computer program code, and the at least one processor, with the at least one memory and the computer program code, being arranged to cause the apparatus at least to prepare at least one beamforming and/or precoding pattern for transmitting a positioning purpose signal via a plurality of antennas connectable to the apparatus, the positioning purpose signal serving to position at least one user equipment, and transmit the positioning purpose signal from the plurality of antennas according to the beamforming and/or precoding pattern.

According to a second aspect of the present invention a method, for use in a transmission device, is provided which comprises
preparing at least one beamforming and/or precoding pattern for transmitting a positioning purpose signal via a plurality of antennas connectable to the transmission device, the positioning purpose signal serving to position at least one user equipment, and
transmitting the positioning purpose signal from the plurality of antennas according to the beamforming and/or precoding pattern.

According to a third aspect of the present invention, an apparatus is provided which comprises at least one processor, at least one memory including computer program code, and the at least one processor, with the at least one memory and the computer program code, being arranged to cause the apparatus at least to create a coordination scheme by which beamforming and/or precoding of transmissions of positioning purpose signals from a plurality of transmission devices each having a plurality of antennas is coordinated, wherein the positioning purpose signals serve to position at least one user equipment, and to forward information indicating the coordination scheme to the transmission devices involved in the coordination scheme.

According to a fourth aspect of the present invention a method is provided which comprises
creating a coordination scheme by which beamforming and/or precoding of transmissions of positioning purpose signals from a plurality of transmission devices each having a plurality of antennas is coordinated, wherein the positioning purpose signals serve to position at least one user equipment, and
forwarding information indicating the coordination scheme to the transmission devices involved in the coordination scheme.

According to a fifth aspect of the present invention, an apparatus, for use in a user equipment, is provided which comprises at least one processor, at least one memory including computer program code, and the at least one processor, with the at least one memory and the computer program code, being arranged to cause the apparatus at least to receive information indicating a coordination scheme, the coordination scheme specifying coordination of beamforming and/or precoding of transmissions of positioning purpose signals from a plurality of transmission devices each having a plurality of antennas, wherein the positioning purpose signals serve to position the user equipment, and receive at least one positioning purpose signal from at least one transmission device based on the coordination scheme.

According to a sixth aspect of the present invention a method, for use in a user equipment, is provided which comprises
receiving information indicating a coordination scheme, the coordination scheme specifying coordination of beamforming and/or precoding of transmissions of positioning purpose signals from a plurality of transmission devices each having a plurality of antennas, wherein the positioning purpose signals serve to position the user equipment, and
receiving at least one positioning purpose signal from at least one transmission device based on the coordination scheme.

The first to sixth aspects of the present invention may be modified as set out in the dependent claims.

According to a seventh aspect of the present invention a computer program product is provided which comprises code means for performing a method according to the second aspect, the fourth aspect or the sixth aspect and/or their modifications when run on a processing means or module. The computer program product may be embodied on a computer-readable medium, and/or the computer program product may be directly loadable into the internal memory of the computer and/or transmittable via a network by means of at least one of upload, download and push procedures.

According to an eighth aspect of the present invention an apparatus is provided which comprises
means for preparing at least one beamforming and/or precoding pattern for transmitting a positioning purpose signal via a plurality of antennas connectable to the transmission device, the positioning purpose signal serving to position at least one user equipment, and
means for transmitting the positioning purpose signal from the plurality of antennas according to the beamforming and/or precoding pattern.

According to a ninth aspect of the present invention an apparatus is provided which comprises
means for creating a coordination scheme by which beamforming and/or precoding of transmissions of positioning purpose signals from a plurality of transmission devices each having a plurality of antennas is coordinated, wherein the positioning purpose signals serve to position at least one user equipment, and
means for forwarding information indicating the coordination scheme to the transmission devices involved in the coordination scheme.

According to a tenth aspect of the present invention an apparatus is provided which comprises
means for receiving information indicating a coordination scheme, the coordination scheme specifying coordination of beamforming and/or precoding of transmissions of positioning purpose signals from a plurality of transmission devices each having a plurality of antennas, wherein the positioning purpose signals serve to position the user equipment, and
means for receiving at least one positioning purpose signal from at least one transmission device based on the coordination scheme.

### BRIEF DESCRIPTION OF THE DRAWINGS

These and other objects, features, details and advantages will become more fully apparent from the following detailed description of embodiments of the present invention which is to be taken in conjunction with the appended drawings, in which:

FIG. 1A shows a BS according to an embodiment of the present invention,

FIG. 1B shows a flowchart of a procedure carried out by a BS according to an embodiment of the present invention,

FIG. 2A shows a LS according to an embodiment of the present invention,

FIG. 2B shows a flowchart of a procedure carried out by a LS according to an embodiment of the present invention,

FIG. 3A shows a UE according to an embodiment of the present invention,

FIG. 3B shows a flowchart of a procedure carried out by a UE according to an embodiment of the present invention, and

FIG. 4 shows a multi-cell area illustrating beamforming of PRS transmissions according to an embodiment of the present invention,

FIG. 5 shows the multi-cell area illustrating a repetition of one PRS ID shown in FIG. 4 to other BS sites according to an embodiment of the present invention, and

FIG. 6 illustrates dynamic beamforming based on roughly know positions of a few T-UEs.

### DETAILED DESCRIPTION OF EMBODIMENTS

In the following, description will be made to embodiments of the present invention. It is to be understood, however, that the description is given by way of example only, and that the described embodiments are by no means to be understood as limiting the present invention thereto.

However, before describing the embodiments, the problem underlying the present application is described in some more detail.

Two major methods are utilized for positioning today.

The first one is positioning based on Global Navigation Satellite Systems (GNSS) with the Global Positioning System (GPS) being the most prominent technology. GPS works well in open areas with line-of-sight to a sufficiently large number of satellites. However, in certain situations (e.g., in tunnels, under bridges, in parking garages, next to buildings, under dense foliage) unhindered line-of-sight may be limited or even excluded. Therefore, positioning information can be inaccurate, and in consequence the required QoS for VRU protection cannot be guaranteed in all situations. Thus, GNSS can just serve as a complementary technology.

The other method is utilizing the cellular access technology, e.g., LTE, for positioning. However, there are several impairments that limit the achievable positioning accuracy in the order of tens of meters, see for example Qualcomm Technologies, “Observed Time Difference of Arrival (OTDOA) Positioning in 3GPP LTE”, White Paper, 2014. The most critical ones are:
Unresolvable multi-path and non-light-of-sight (NLOS) propagation, e.g. falsification of OTDOA measurements due to reflection, diffraction, scattering and blocking.
Insufficient synchronization between base stations

Insufficient number of measurable base stations in the area of interest

According to some embodiments of the present invention, it is focused on the latter issue. The main problem caused by an insufficient number of measurable base stations is the bad performance of the multilateration algorithm determining the UE position depending on a set of OTDOA measurements with a Maximum Likelihood (ML) or a Maximum-A-Posteriori (MAP) estimator. In principle three base stations, i.e., two OTDOA measurements, suffice for 2D-positioning (x-y-coordinates or latitude/longitude), however each additional available measurement decreases the area that is characterized by a high probability that the true location is within this area. In other words, the positioning error decreases with increasing number of measurable base stations. However, in a given deployment, the number of base stations is fixed. Consequently, there may be areas where the QoS requirements of the abovementioned use cases cannot be fulfilled.

The best existing solution to increase the number of measurable base stations is Positioning Reference Signal (PRS) muting (see, for example, 3GPP TS 36.355 V14.4.0 (2017 December)). This feature was recently enabled in the Verizon network nationwide in the US. According to a configured muting pattern the base stations transmit at a subset of the PRS opportunities with “zero power”. If the PRS of the serving base station, normally received with highest signal strength, is muted, the PRS from a more distant base station sent on the same time-frequency resources becomes “measurable”, i.e. its SINR becomes high enough so that the UE can take an OTDOA measurement from the distant base station.

The main drawback of PRS muting is the reduced update rate of the OTDOA measurement with respect to one particular base station, i.e. the measurements are likely to become outdated if the UE moves with high velocity, which again mitigates the positioning accuracy, e.g., for a car. Therefore, in this invention submission we aim at a scheme avoiding or, at least, minimizing any PRS muting.

Another straightforward solution is to deploy additional transmission points in the cell aiming to increase the number of measurable base station. Two basic principles can be distinguished:

The first basic principle is that transmission points use LTE as radio access technology and transmit solely PRS. Advantages are that the radio access network has full control over the transmission points, and that it is ensured that the UEs fully support this extended positioning because from their perspective the transmission points appear just as additional base stations for OTDOA measurements.

However, the number of non-overlapping time-frequency patterns, where PRS can be sent, is limited to M (see 3GPP TS 36.211 V15.0.0 (2017 Decemebr), for example, where M=6). In other words, both base stations and additional transmission points in the deployment share in total M different time-frequency patterns for PRS. Two transmission points transmitting their PRS on the same time-frequency pattern suffer from some residual interference as the PRS are pseudo-random sequences without perfect orthogonality in the code domain. The presence of additional transmission points for PRS densifies the reuse pattern (smaller distance between two PRS transmitters utilizing the same pattern) and thus increases the mean interference level on the PRS. PRS muting can be applied to reduce the interference with the same drawback as described before.

The second basic principle is that transmission points use any other Radio Access Technology (RAT), e.g., WLAN, Bluetooth, Terrestrial Beaconing System. Regarding the addressed Intelligent Transportation System (ITS) use cases, a couple of severe drawbacks may occur:

For example, a combination of different RATs comes along with enhanced signalling overhead between the radio access network, its base stations, the supporting transmission points using a different RAT and the UEs that must be aware of that.

Moreover, it is not ensured that the UEs support the RAT of the transmission points. At least it is additional effort for the UE. Eventually the UE has to switch permanently between two different frequency bands during measuring.

Furthermore, as the transmission points typically transmit the supporting positioning signal in an unlicensed band, it may happen that measurements are significantly falsified through superimposed transmissions originating from another source, not involved in the positioning.

Hence, it is desirable to improve the positioning accuracy. According to embodiments of the present invention, a beamforming and coordination scheme for Positioning Reference Signals (PRS) is provided that can significantly enhance the capabilities of the existing LTE positioning with Observed Time Difference of Arrival (OTDOA).

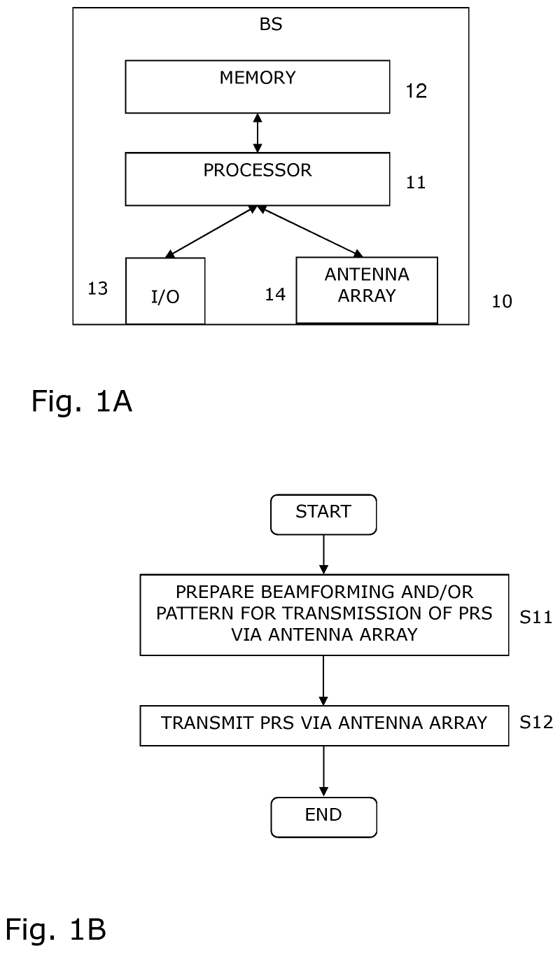

In the following, a general overview of an embodiment of the present invention is described by referring to FIGS. 1A, 1B, 2A, 2B, 3A and 3B.

In particular, FIG. 1A shows a BS 10 as an example for a first apparatus or transmission device according to the present embodiment. The BS 10 comprises at least one processor 11 and at least one memory 12 including computer program code. The at least one processor 11, with the at least one memory 12 and the computer program code, is arranged to cause the apparatus at least to prepare at least one beamforming and/or precoding pattern for transmitting a positioning purpose signal via a plurality of antennas connectable to the apparatus, the positioning purpose signal serving to position at least one user equipment, and transmit the positioning purpose signal from the plurality of antennas according to the beam.

In other words, by referring to the flowchart shown in FIG. 1B, in step S11, a beamforming and/or precoding pattern for transmission of a positioning purpose signal (e.g., a positioning reference signal (PRS)) via an antenna array (as an example for the plurality of antennas) is prepared. In step S12, the positioning purpose signal (e.g., PRS) is transmitted via the antenna array.

It is noted that the BS 10 is only an example for the first apparatus or transmission device. Alternatively, the apparatus may be any kind of device, which may also include a program or code that is able to transmit or to control transmission of positioning purpose signals via a plurality of antennas in a beamforming and/or precoding pattern. Moreover, the apparatus may be a controller for a transmission device such as a BS. Hence, the plurality of antennas may be part of the apparatus, or the plurality of antennas may not be part of the apparatus, but is connectable thereto.

The beamforming and/or precoding pattern may be a pattern which specifies how beamforming or precoding is to be carried out. For example, the pattern may specify center_beam_azimuth, center_beam_elevation and beam_width etc. When precoding is applied, the pattern may specify weights to be applied to the different antennas of the plurality of antennas.

The beamforming and/or precoding pattern may be prepared such that a received signal power of the positioning purpose signal is maximized in a certain area, and/or the received signal power of the positioning purpose signal is minimized in another area.

The transmission device may comprise the antenna array 14 shown in FIG. 1A (as an example for the plurality of antennas mentioned above).

Moreover, the beamforming and/or precoding pattern may be created based on a coordination scheme, in which beamforming of transmission of positioning purpose signals from a plurality of transmission devices are coordinated.

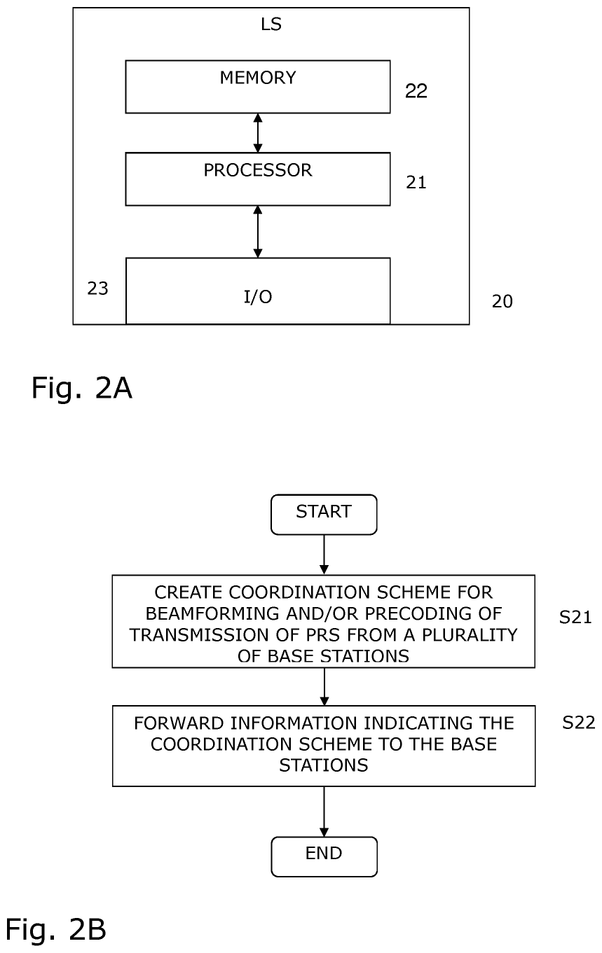

FIG. 2A shows a localization coordinating entity or location server (LS) 20 as an example for a second apparatus according to the present embodiment. The LS 20 comprises at least one processor 21 and at least one memory 22 including computer program code. The at least one processor 21, with the at least one memory 22 and the computer program code, is arranged to cause the apparatus at least to create a coordination scheme by which beamforming and/or precoding of transmissions of positioning purpose signals from a plurality of transmission devices each having a plurality of antennas is coordinated, wherein the positioning purpose signals serve to position at least one user equipment, and to forward information indicating the coordination scheme to the transmission devices involved in the coordination scheme.

In other words, by referring to the flowchart shown in FIG. 2B, in step S21, a coordination scheme for beamforming of transmission of a positioning purpose signal (e.g., PRS) via a plurality of transmission devices (e.g., BS 10 shown in FIG. 1A) is created. In step S22, information indicating coordination scheme is forwarded to the transmission devices.

The LS or localization coordinating entity is only an example for the second apparatus, and can be any other suitable network element which is able to create a coordination scheme for a plurality of transmission devices. For example, the second apparatus may also be part of a BS, eNB or the like.

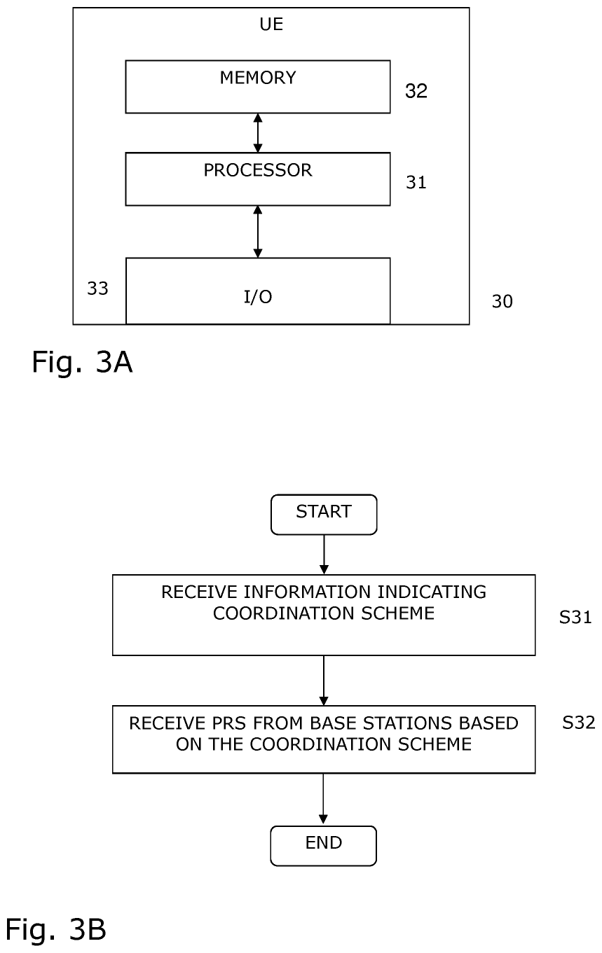

FIG. 3A shows a user equipment (UE) 30 as an example for a third apparatus according to the present embodiment. The UE 30 comprises at least one processor 31 and at least one memory 32 including computer program code. The at least one processor 31, with the at least one memory 32 and the computer program code, is arranged to cause the apparatus at least to receive information indicating a coordination scheme, the coordination scheme specifying coordination of beamforming and/or precoding of transmissions of positioning purpose signals from a plurality of transmission devices each having a plurality of antennas, wherein the positioning purpose signals serve to position the user equipment, and to receive at least one positioning purpose signal from at least one transmission device (e.g., BS 10 shown in FIG. 1A) based on the coordination scheme.

In other words, by referring to the flowchart shown in FIG. 3B, in step 31, the UE 30 receives the information which indicates the coordination scheme. In step S32, at least one positioning purpose signal from at least one transmission device (e.g., BS 10 shown in FIG. 1A) is received based on the coordination scheme.

Hence, according to embodiments of the present invention, transmission devices (such as BS) perform beamforming according to a coordination scheme. In this way, certain areas may be targeted with a high received signal power, whereas other areas may be targeted with low received signal power. In this way, the number of measurable transmission devices for a UE can be increased.

In other words, according to embodiments of the present invention, beamforming or precoding of PRS transmissions is used in combination with a coordination scheme between base stations aiming at increasing the number of measurable base stations at a target UE for OTDOA measurements within a given time interval T.

It is noted that the BS 10 and the LS 20 may further comprise input/output (I/O) units or functions (interfaces) 13 connected to the processor 11, and also the LS 20 may further comprise input/output (I/O) units or functions (interfaces) 23 connected to the processor 21, in order to provide connections to other elements. In particular, the I/O units or functions 23 may receiver/transmitter units. Similarly, the UE 30 may further comprise input/output (I/O) units or functions (interfaces) 33 connected to the processor 31. For example, the I/O units or functions 33 may comprise a receiver/transmitter unit.

In the following, some more details of embodiments of the present invention are described.

According to some embodiments of the present invention the transmission of PRS from a multi-antenna base station (BS) to at least one target UE (T-UE) is beamformed or precoded aiming at
Maximize the received signal power of the PRS in a preferred area A, and/or
Minimize the received signal power of the PRS in a non-preferred area B.

Moreover, according to some embodiments, a coordination scheme between a number N of BSs, each transmitting one out of M<N orthogonal realizations of the PRS, in the following referred to as PRS ID, is provided such that the number of measurable BSs for OTDOA measurements within a given time duration T is maximized, and their interference at all the interested T-UEs is minimized through an advantageous beamforming pattern from the N BSs, and consequently the positioning error of the T-UE is minimized. Measurable BS means that the T-UE receives the PRS from said BS with sufficiently high SINR so that it can take a meaningful OTDOA measurement. The time duration T depends on the application. As an example, a fast driving car requires a small value of T, in the order of 100 ms, to avoid outdated position estimates.

Examples for the messaging and the protocols between BS, T-UE and the localization coordinating entity, the Location Server (LS) hereafter, to configure this PRS transmission are described later.

In contrast to the existing solution operating with PRS muting only, according to embodiments of the present invention, a subset of the PRS

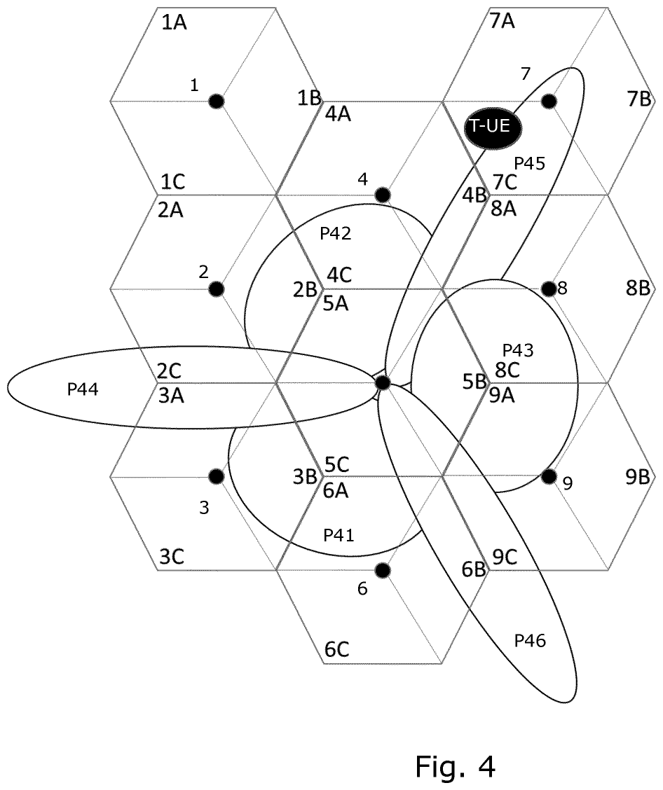

IDs with sharp beams pointing to adjacent cells is transmitted as indicated in FIG. 4.

FIG. 4 shows a multi-cell area with BS sites 1 to 9 (indicated by black dots) and each BS illuminating one 120° sector, the sectors being denoted by reference characters 1A, 1B, 1C, . . . to 9A, 9B and 9C. Six different mutually orthogonal PRS IDs are sent by six different beams denoted by reference characters P41 to P46. Three PRS are sent with a broadcast pattern (P41, P42 and P43). The three remaining PRS are sent with a directive beamforming pattern targeting T-UEs in neighbouring cells (P44, P45 and P46).

The purpose is that, for example, the T-UE located in cell 7C can take an OTDOA measurement from BS site 5, which would not be possible with the existing solution without muting the respective PRS ID at BS site 7. A PRS ID corresponds to one of the beams P41 to P46 indicated in FIG. 4. The solution according to the present embodiment enables measurements of PRS sent from BS site 5 at the same PRS transmission slot at both T-UEs located in the cell range of BS site 5 itself, and distant T-UEs located in surrounding cell areas, e.g., the T-UE in cell 7C shown in FIG. 4. In doing so, the number of meaningful OTDOA measurements during the time period T is maximized.

Moreover, it is noted that the PRS in the downlink, as standardized for positioning purposes at the moment, is only an example for a positioning purpose signal. That is, the positioning purpose signal is not limited to PRS, and can be any kind of radio signal transmitted for the purpose of positioning. That is, according to some embodiments of the present invention, a general concept of precoding/beamforming the transmission of any other radio signals transmitted for the purpose of positioning is provided to increase the number of measurable transmitters, limiting the interference from not-desired transmitters in the process. One example for that is a Supporting PRS (S-PRS) signal sent from a Supporting UE (S-UE) to the T-UE on sidelink resources. Lampposts along a street can be equipped with these S-UEs, each of them transmitting advantageously beamformed/precoded S-PRS to a car driving by.

In the following, some more details of the above embodiments are described.

As mentioned above, it is an aim to increase the number of measurable BSs at a T-UE to increase the number of OTDOA measurements from these BSs within the given time duration T, achieving highly accurate positioning of the T-UE.

First of all, thanks to beamforming gains one can extend the range of these PRS in the interested direction that the system wants to monitor.

In doing so, the following degrees of freedom are achieved:

A: Each BS transmits one out of M different PRS IDs. These M PRS IDs are mutual orthogonal in the sense that disjoint sets of time-frequency resources, so called patterns, are utilized. As an example, the M=6 PRS patterns defined in 3GPP TS 36.355 V14.4.0 (2017 December) can be used.

B: According to the present embodiment, the possibility is provided that each BS steers the transmitted PRS in a preferred area A, and/or avoids transmitting any signal power in a non-preferred area B by beamforming or precoding of the PRS. The beamforming/precoding decisions can depend on a coordination scheme.

This coordination scheme between a number N of BS aims to

i) maximizing the SINR on received PRS in a certain area, or for certain T-UEs,

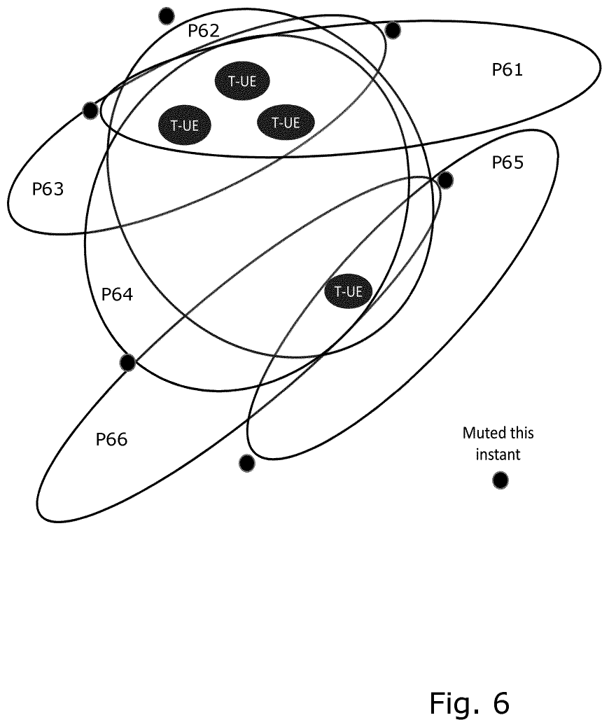

ii) drastically reducing the interference power produced by BS X in a certain preferred area of BS Y, both transmitting the same PRS ID. This can be done to temporarily increase the number of BS illuminating the same T-UE, since BS far away from the T-UE can transmit a sharp beam in that T-UE's direction, without impacting a huge area around (e.g. see FIG. 6 described in the following).

iii) not transmitting in an area B where the BS has strong NLOS degradation, but still can bring some interference to few positions in B.

The beamforming/precoding decisions can furthermore depend on rough knowledge of the T-UEs' position at the BS or LS, and/or prediction of future positions of at least one T-UE at the BS or the LS based on previous positions or supporting information like a street map.

C: Periodicity of PRS transmissions

According to a preferred embodiment of the invention, the abovementioned parameters are selected (e.g., by the LS) jointly in such a way that the number of OTDOA measurements from measurable BSs within a given time period T is maximized and the interference brought to other users is minimized. A measureable (detectable) BS is defined as a BS whose PRS is received at the T-UE with a SINR higher than a threshold y, depending on the BS and the T-UE's position. T is defined by the application and may range in the orders of magnitude between 10 ms and 10 s. The higher the speed of the T-UE, the shorter must be chosen T in order to get accurate position estimates in real time.

The so called PRS beamforming pattern is defined as the set of all
PRS ID from 0 to (M−1): It refers to the considered PRS pattern among the M possible orthogonal ones.
Time absolute allocation: information regarding the time allocation of the PRS transmissions. The information about the periodicity should be properly shared to each node.
Beamforming/precoding pattern defining the directivity of the PRS transmission. Examples are:
An example for such a beamforming/precoding pattern is a broadcast pattern aiming to cover the whole cell area optimized for T-UEs close the transmitting BS.
Another example for such a beamforming/precoding pattern is a directive pattern sharply steering the main portion of the power in a preferred direction optimized for T-UEs far from the transmitting BS, in particular T-UEs located in adjacent cells, but requiring an OTDOA measurement from the transmitting BS. For example, the signaling to communicate this beamforming/precoding pattern may comprise information concerning beamforming such as center_beam_azimuth, center_beam_elevation and beam_width.

The PRS beamforming is coordinated between the N cells which can mean that in each PRS transmission slot a different PRS beamforming pattern is utilized. As an example, the sharply beamformed PRS IDs may rotate over time in order to illuminate different target areas in the adjacent cells, while illumination of the target area from multiple BS sending the same PRS ID is avoided. For example, the signaling may comprise the rotation speed (e.g. +30 degree every transmission) and behavior (e.g. maximum and minimum angle).

In the following, two examples to schedule such directional PRS with beamforming/precoding pattern are described. One is stationary with respect to the T-UEs position and cell history, and only updated once in a while, e.g. every hour, by the LS. The other is updating the beamforming pattern very quickly, based on T-UEs positions and QoS requirements.

In the following, an embodiment is described according to which a stationary beamforming pattern scheduling is applied.

The beamforming pattern in this case is independent from the T-UEs positions and demands. This is the case when a lot of different T-UEs must be tracked simultaneously, with a sufficient number of advantageously placed BSs.

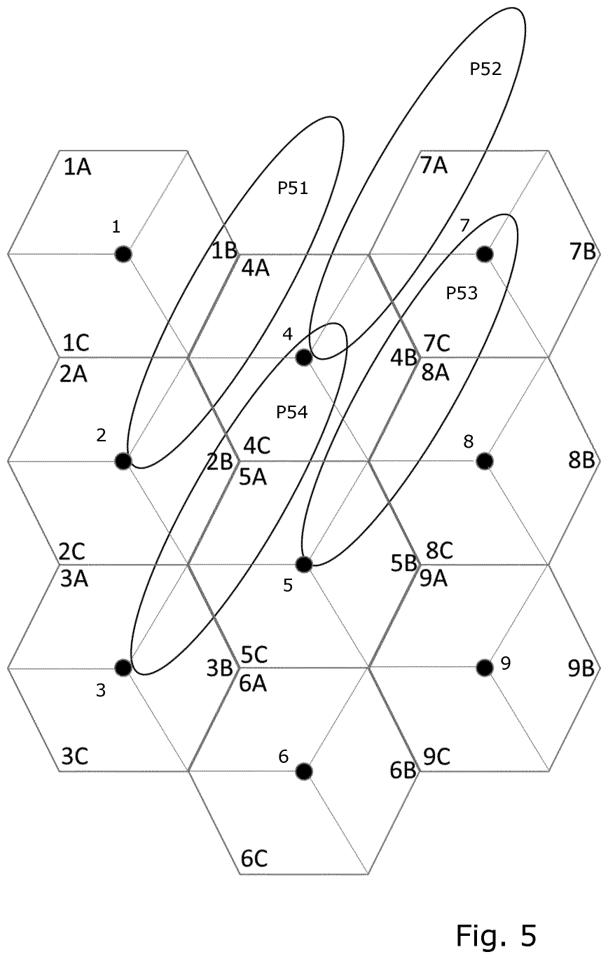

In FIG. 4 described above, there is an example of PRS transmission of M=6 orthogonal PRS IDs from one BS 5 in the same PRS transmission time slot. This pattern is replicated in FIG. 5 for only one PRS ID, to show the effect of multiple BSs performing transmission in the same way.

FIG. 5 illustrates a repetition of one PRS ID shown in FIG. 4 to other BS sites to demonstrate that beams indicated by reference characters P51 to P54, sent from BS sites 2, 3, 4 and 5 do almost not overlap and allow to serve farthest regions. This indicates a high SINR of OTDOA measurements. As one can notice, the mutual interference is minimized, thanks to the sharp shape of the beams.

The example shown in FIGS. 4 and 5 works as follows:

Each BS always transmits 3 PRS in its 120 degrees sectors.

Furthermore, each BS transmits the 3 other beamformed PRS, achieving a beamforming gain and sharpening the area where the PRS signal can be perceived. Please note that these beamformed PRS are intentionally steered in neighboring cells to allow T-UEs located in these neighboring cells taking OTDOA measurements with respect to the transmitting BS. These three beams start with an offset of 0, 120, 240 degrees respectively, and then rotate with 120/K degrees at the next PRS transmission slot, e.g. 40 degrees with K=3. Therefore, the periodicity of the PRS measurement coming from the same BS site in the same area is K=3. In FIG. 4, it is coarsely plot the radiation pattern at the first PRS transmission slot, generating the radiation in FIG. 5 when one turns on all BSs. Note that K is independent of M.

The configuration of the beamforming pattern could be shared also with the T-UE. Hence, according to an embodiment, the location server (LS) and/or the base station (BS) include means to inform the T-UE about the beamforming pattern configuration. This can be achieved by an extension of the existing LTE Positioning Protocol (LPP) (see 3GPP TS 36.355 V14.4.0 (2017 December)), i.e. adding respective new information fields. However, the invention is not limited to LPP, but can be applied on other kind of positioning protocol as well, for example also in a New Radio (NR) positioning protocol.

As one can see, with this simple scheme, without the need of any muting pattern, the T-UE can sense the BS5 (as well as two other BS not shown in the Figure, from yellow and grey PRS), that could not be sensed with a typical broadcast-like transmission of M=6 PRS without applying muting.

According to another embodiment of the present invention, an on the fly beamforming pattern scheduling is applied.

In particular, according to this embodiment, the beamforming pattern is adapted based on rough previous position estimates in the case that only few T-UEs should be tracked.

In this way, the scheduler of the BS of interest can act as depicted in FIG. 6. FIG. 6 shows an illustration of dynamic PRS beamforming based on roughly known positions (e.g., estimated positions) of a few T-UEs.

In FIG. 6 it is illustrated, with M=4, how the system has configured the beamforming pattern of the PRS such that each T-UE is illuminated by M=4 BSs at the same PRS transmission slot. In order to achieve this, some sharper beams are scheduled, namely the beams P61, P63, P65 and P66, while the other two beams P62 and P64 are radiating in a broader range. Note that, in this particular case, a BS is muted, since with M=4 aliases could be created (with M=5 everything gets ok again). Hence, it is needed to schedule muting patterns in the future instants to get measurements also from the muted BS, if the achieved positioning confidence of the users is not enough. It is noted that due to beamforming as applied according to this embodiment, even the farthest users can benefit from a very distant node.

The invention is not limited to the specific embodiments described above, and various modifications are possible.

For example, according to some embodiments, the localization coordinating entity or Location Server (LS) has been described as a separate entity (dedicated network control element) for controlling the BSs in the coordination scheme. However, alternatively the localization coordinating entity may also be a part of one of the BSs involved, or may be a part of another suitable network control element.

Moreover, the base stations (BSs) are only examples for transmission devices for transmitting positioning purpose signals in a beamforming and/or precoding pattern from a plurality of antennas.

Furthermore, according to some embodiments, it is described that the PRS with different ID (1, . . . , M) are orthogonal to each other if transmitted in the same time/frequency, however the invention is not limited to these sequences. That is, one can use signals to take OTDOA/Carrier Phase measurements that are not fully orthogonal in time/frequency, but are separated by the fact that they are transmitted in different space, applying beamforming.

Moreover, according to some embodiments, it is described that transmission of a signal is beamformed/precoded that can be used to perform OTDOA. However, the invention is not limited to this. That is, also any other measurements can be performed by using the beamformed/precoded transmission of these signals, e.g. carrier phase.

In general, various embodiments of the UE can include, but are not limited to, mobile stations, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The memories 12, 22 and 23 may be of any type suitable to the local technical environment and may be implemented using any suitable data storage technology, such as semiconductor based memory devices, magnetic memory devices and systems, optical memory devices and systems, fixed memory and removable memory. The processors 11, 21 and 32 may be of any type suitable to the local technical environment, and may include one or more of general-purpose computers, special purpose computers, microprocessors, digital signal processors (DSPs) and processors based on a multi core processor architecture, as non-limiting examples.

Further, as used in this application, the term “circuitry” refers to all of the following:

(a) hardware-only circuit implementations (such as implementations in only analog and/or digital circuitry) and

(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and

(c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

It is to be understood that the above description is illustrative of the invention and is not to be construed as limiting the invention. Various modifications and applications may occur to those skilled in the art without departing from the true spirit and scope of the invention as defined by the appended claims.

1-7. (canceled)

8. An apparatus comprising at least one processor, at least one non-transitory memory including computer program code, the at least one processor, with the at least one memory and the computer program code, being arranged to cause the apparatus at least to:
create a coordination scheme by which beamforming and/or precoding of transmissions of positioning purpose signals from a plurality of transmission devices each having a plurality of antennas is coordinated, wherein the positioning purpose signals servo are configured to position at least one user equipment, and
forward information indicating the coordination scheme to the plurality of transmission devices involved in the coordination scheme.

9. The apparatus according to claim 8, wherein the at least one processor, with the at least one memory and the computer program code, are arranged to cause the apparatus further to:
create the coordination scheme such that a received signal power of the positioning purpose signal is maximized in a certain area, and/or such that a signal-to-noise-and-interference ratio of the received positioning purpose signal exceeds a certain threshold in a certain area.

10. The apparatus according to claim 8, wherein the at least one processor, with the at least one memory and the computer program code, are arranged to cause the apparatus further to:
create the coordination scheme based on locations of the transmission devices and/or geographical conditions of an area in which a positioning process is to be carried out, and/or based on an estimated position of the user equipment to be positioned.

11. The apparatus according to any one of the claims 8 to 10 claim 8, wherein the at least one processor, with the at least one memory and the computer program code, are arranged to cause the apparatus further to:
create the coordination scheme such that the transmission devices are instructed to change beamforming and/or precoding of transmissions of the positioning purpose signals within a given time duration.

12. The apparatus according to any one of the claims 8 to 11 claim 8, wherein the at least one processor, with the at least one memory and the computer program code, are arranged to cause the apparatus further to:
forward information indicating the coordination scheme to the user equipment via at least one of the transmission devices.

13. An apparatus, for use in a user equipment, comprising at least one processor, at least one non-transitory memory including computer program code, and the at least one processor, with the at least one memory and the computer program code, being arranged to cause the apparatus at least to:
receive information indicating a coordination scheme, the coordination scheme specifying coordination of beamforming and/or precoding of transmissions of positioning purpose signals from a plurality of transmission devices each having a plurality of antennas, wherein the positioning purpose signals serve to position the user equipment, and
receive at least one positioning purpose signal from at least one transmission device based on the coordination scheme.

14. The apparatus according to claim 13, wherein the positioning purpose signals are represented by a plurality of predetermined values which are orthogonal to each other, and the information indicating the coordination scheme comprises information which of the predetermined values is used by which transmission device.

15-20. (canceled)

21. A method comprising,
creating a coordination scheme by which beamforming and/or precoding of transmissions of positioning purpose signals from a plurality of transmission devices each having a plurality of antennas is coordinated, wherein the positioning purpose signals serve to position at least one user equipment, and
forwarding information indicating the coordination scheme to the transmission devices involved in the coordination scheme.

22. The method according to claim 21, further comprising:
creating the coordination scheme such that a received signal power of the positioning purpose signal is maximized in a certain area, and/or such that a signal-to-noise-and-interference ratio of the received positioning purpose signal exceeds a certain threshold in a certain area.

23. The method according to claim 21 or 22, further comprising:
creating the coordination scheme based on locations of the transmission devices and/or geographical conditions of an area in which a positioning process is to be carried out and/or based on an estimated position of the user equipment to be positioned.

24. The method according to any one of the claims 21 to 23 claim 21, further comprising:
forwarding information indicating the coordination scheme to the user equipment via at least one of the transmission devices.

25. (canceled)

26. A computer program product comprising code, encoded on a non-transitory medium, configured to perform the method according to claim 21 when run on at least one processor.
